(19) United States
(12) Patent Application Publication
(10) Pub. No.: US 2022/0264623 A1
(43) Pub. Date: Aug. 18, 2022

(54) PRIORITY DIFFERENTIATION OF SR TRANSMISSIONS WITH PERIODIC/SEMI-PERSISTENT CSI REPORT

(71) Applicant: SHARP KABUSHIKI KAISHA, Sakai City, Osaka (JP)

(72) Inventor: ZHANPING YIN, Vancouver, WA (US)

(21) Appl. No.: 17/628,129

(22) PCT Filed: Jul. 22, 2020
(86) PCT No.: PCT/JP2020/028574

§ 371 Date: Jan. 18, 2022

Related U.S. Application Data
(60) Provisional application No. 62/878,179, filed on Jul. 24, 2019.

(51) Int. Cl. H04W 72/12

(52) U.S. Cl. CPC H04W 72/1284; H04W 72/1242

(57) ABSTRACT

A UE is configured to transmit PUCCHs for respective SRs with SR transmission occasions that would overlap with a transmission of a PUCCH with CSI with normal BLER requirements in a resource using PUCCH format 2, 3, or 4 in a subslot of a slot. The UE includes processing circuitry configured to append SR information bits to periodic/semi-persistent CSI information bits using PUCCH format 2, 3, or 4, and transmitting circuitry configured to transmit combined UCI bits, having the periodic/semi-persistent CSI information bits and the SR information bits, in a PUCCH for CSI reporting using the PUCCH resource for the periodic/semi-persistent CSI information bits with PUCCH format 2, 3, or 4. A number of the SR information bits is based on a total number of SRs with all priority configurations, or SRs with low priority configurations, whose PUCCH resources overlap with the PUCCH resource for periodic/semi-persistent CSI in the slot.

### TECHNICAL FIELD

The present disclosure generally relates to wireless communication, and more particularly, to priority differentiation of scheduling request (SR) transmissions with periodic/semi-persistent Channel State Information (CSI) report of different service types.

### BACKGROUND ART

In the current 3rd Generation Partnership Project (3GPP) specifications, physical uplink control channels (PUCCHs) for periodic/semi-persistent Channel State Information (CSI) can be configured with PUCCH format 2, 3, or 4. In case of PUCCH resource overlapping, SR may be multiplexed to CSI by appending extra bits to the CSI, and reported on the PUCCH resource configured for periodic/semi-persistent CSI.

With support of different service types, the PUCCH for periodic/semi-persistent CSI may be configured separately for ultra-reliable low latency-communication (URLLC) with different periodicities and error probability criteria. Also, the SR priority may be known to UE at physical (PHY) layer.

Therefore, there is a need in the art to investigate methods for indicating SR priority in case of a collision between periodic/semi-persistent CSI and SR considering the block error rate (BLER) performance requirements for a given CSI report in the next generation (e.g., fifth generation (5G) new radio (NR)) wireless communication networks.

### SUMMARY OF INVENTION

In one example, a user equipment (UE) comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, processing circuitry of the UE is configured to prepend SR information bits to periodic/semi-persistent CSI information bits using PUCCH format 2 or PUCCH format 3 or PUCCH format 4; and determine a PUCCH to be transmitted based on whether a high priority SR is to be reported; transmitting circuitry of the UE is configured to transmit the selected PUCCH.

In one example, a method by a user equipment (UE), the method comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, prepending SR information bits to periodic/semi-persistent CSI information bits using PUCCH format 2 or PUCCH format 3 or PUCCH format 4; and determining a PUCCH to be transmitted based on whether a high priority SR is to be reported; transmitting the selected PUCCH.

In one example, a gNB comprising: when the gNB configures a UE to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, processing circuitry of the gNB is configured to determine a PUCCH is received at the configured PUCCH resources receive the uplink control information (UCI) on the PUCCH.

In one example, a method by a gNB, the method comprising: when the gNB configures a UE to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, determining a PUCCH is received at the configured PUCCH resources receiving the uplink control information (UCI) on the PUCCH.

### BRIEF DESCRIPTION OF DRAWINGS

Implementations of the present technology will now be described, by way of example only, with reference to the attached figures.

FIG. 1 shows a SchedulingRequestResourceConfig information element.

FIG. 2 shows a CSI-ResourcePeriodicityAndOffset Information element.

FIG. 3A is a flowchart diagram illustrating a method of a UE for handling SRs with all priorities and CSI having similar BLER (normal) requirements, in accordance with example implementations of the present application.

FIG. 3B is a flowchart diagram illustrating a method of a UE for handling SRs with all priorities and CSI having similar BLER (normal) requirements, in accordance with example implementations of the present application.

FIG. 4A is a flowchart diagram illustrating a method of a UE for handling SRs with all priorities with SR differentiation by multiplexing low priority SR and CSI having similar BLER (normal) requirements, in accordance with example implementations of the present application.

FIG. 4B is a flowchart diagram illustrating a method of a UE for handling SRs with all priorities with SR differentiation by multiplexing low priority SR and CSI having similar BLER (normal) requirements, in accordance with example implementations of the present application.

FIG. 5A is a flowchart diagram illustrating a method of a UE for handling SRs with all priorities and CSI with ultra-reliability requirements, in accordance with example implementations of the present application.

FIG. 5B is a flowchart diagram illustrating a method of a UE for handling SRs with all priorities and CSI with ultra-reliability requirements, in accordance with example implementations of the present application.

FIG. 6A is a flowchart diagram illustrating a method of a UE for handling SRs with all priorities with SR differentiation by multiplexing high priority SR and CSI with ultra-reliability requirements, in accordance with example implementations of the present application.

FIG. 6B is a flowchart diagram illustrating a method of a UE for handling SRs with all priorities with SR differentiation by multiplexing high priority SR and CSI with ultra-reliability requirements, in accordance with example implementations of the present application.

### DESCRIPTION OF EMBODIMENTS

The 3GPP is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access network system (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12, 13, 14 and/or 15) including New Radio (NR) which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a next Generation Node B (gNB) or some other similar terminology. As the scope of the disclosure should not be limited to 3GPP standards, the terms “base station,” “Node B,” “eNB,” “HeNB,” and “gNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra-Reliable and Low Latency Communication) transmission, and mMTC (massive Machine Type Communication) transmission. Also, in NR, single-beam and/or multi-beam operations is considered for downlink and/or uplink transmissions.

In order for the services to use the time/frequency/space resource efficiently, it would be useful to be able to efficiently control uplink transmissions. Therefore, a procedure for efficient control of uplink transmissions should be designed. However, the detailed design of a procedure for uplink transmissions has not been studied yet.

According to the systems and methods described herein, a UE may transmit multiple reference signals (RSs) associated with one or more Transmission Reception Points (TRPs) on a UL antenna port. For example, multiple UL RSs respectively associated with one or more TRPs may be transmitted on a UL antenna port. Namely, there may be one or more UL RSs transmitted per UL antenna port. Also, there may be one or more UL RSs transmitted per TRP.

In an example, one TRP may be associated with one UL antenna port. In another example, one TRP may be associated with multiple UL antenna port(s). In another example, multiple TRP(s) may be associated with multiple UL antenna port(s). In yet another example multiple antenna port(s) may be associated with one UL antenna port. The TRP(s) described herein are assumed to be included in the antenna port(s) for the sake of simple description.

Here, for example, multiple UL RSs transmitted on an UL antenna port may be defined by a same sequence (e.g., a demodulation reference signal sequence, and/or a reference signal sequence). For example, the same sequence may be generated based on a first parameter configured by a higher layer. The first parameter may be associated with a cyclic shift, and/or information associated with a beam index.

Or, multiple UL RSs transmitted on an UL antenna port may be identified by a different sequence. Each of the different signal sequence may be generated based on each of more than one second parameter(s) configured by a higher layer. One second parameter among more than one second parameters may be indicated by DCI. Each of the second parameters may be associated with a cyclic shift, and/or information associated with a beam index.

Also, resource element(s) to which multiple UL RSs transmitted on a UL antenna port are mapped may be defined by the same value of a frequency shift. For example, the same value of the frequency shift may be given by a third parameter configured by a higher layer. The third information may be associated with a beam index.

Alternatively, resource element(s) to which multiple UL RSs transmitted on a UL antenna port are mapped may be identified by different values of a frequency shift. Each of the different values of the frequency shift may be given by each of more than one fourth parameter(s) configured by a higher layer. One fourth parameter among more than one parameters may be indicated by DCI. Each of the fourth parameters may be associated with a beam index.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

In various implementations of the present application, SR priority may be determined based on periodicity in the number of symbols or time duration. At least two levels of SR priority may be defined, for example, high priority and low priority.

In various implementations of the present application, when a positive SR is multiplexed with other uplink control information (UCI), the SR priority may also be indicated.

In various implementations of the present application, the SR multiplexing behavior may be different for different CSI feedback considering the BLER requirements for a particular service type.

In various implementations of the present application, the collisions between SR and periodic/semi-persistent CSI on PUCCH format 2 or PUCCH format 3 or PUCCH format 4 are considered. Currently, extra bits indicating a negative or positive SR among K SR resources that overlap with CSI PUCCH are appended to the CSI bits for joint CSI and SR transmission.

In various implementations of the present application, different handlings for different periodic/semi-persistent CSI for different service types (e.g., different timing and BLER requirements) and SR priorities are described.

In one implementation, when a PUCCH is configured for periodic/semi-persistent CSI with normal BLER requirements (e.g., BLER being 10\hat{ }−2 or less) with PUCCH format 2 or PUCCH format 3 or PUCCH format 4, a UE may count all SR configurations (e.g., a total number (K₁) of SRs with all priority configurations (e.g., high and low priority configurations)), whose PUCCH resources overlap with the PUCCH resource for periodic/semi-persistent CSI with normal BLER requirements with PUCCH format 2 or PUCCH format 3 or PUCCH format 4 in the slot; append SR information bits (e.g., by multiplexing) to periodic/semi-persistent CSI information bits using PUCCH format 2 or PUCCH format 3 or PUCCH format 4, where the number of the SR information bits is obtained by O_{SR}=┌ log₂(K₁+1)┐=ceil(log₂+1)), where ceil(x) or ┌x┐ is a ceiling function that returns the smallest integer that is greater or equal to x; and transmit combined uplink control information (UCI) bits, having the periodic/semi-persistent CSI information bits and the SR information bits, in a PUCCH using the PUCCH resource for the periodic/semi-persistent CSI information bits with PUCCH format 2 or PUCCH format 3 or PUCCH format 4. Also, the index of the positive SR with the highest priority is reported, and an all-zero value for the appended SR bits represents a negative SR value across all overlapping SRs. Special handling methods are defined under certain timing constraints and/or BLER performance criteria. In general, an SR with high priority has a higher priority than that of a CSI. If the CSI and SR multiplexing cannot be performed, the PUCCH for a positive SR with high priority should be transmitted and the PUCCH for CSI may be dropped or punctured.

In one implementation, when a PUCCH is configured for periodic/semi-persistent CSI with normal BLER requirements (e.g., BLER being 10\hat{ }−2 or less) with PUCCH format 2 or PUCCH format 3 or PUCCH format 4, a UE may count only SR with low priority configurations (e.g., a total number (K₂) of SRs with low priority configurations, ignoring SR with high priority configurations), whose PUCCH resources overlap with the PUCCH resource for periodic/semi-persistent CSI with normal BLER requirements with PUCCH format 2 or PUCCH format 3 or PUCCH format 4 in the slot; append SR information bits (e.g., by multiplexing) to periodic/semi-persistent CSI information bits using PUCCH format 2 or PUCCH format 3 or PUCCH format 4, where the number of the SR information bits is obtained by O_{SR}=ceil(log₂(K₂+1)); and transmit combined uplink control information (UCI) bits, having the periodic/semi-persistent CSI information bits and the SR information bits, in a PUCCH using the PUCCH resource for the periodic/semi-persistent CSI information bits with PUCCH format 2 or PUCCH format 3 or PUCCH format 4. For a positive SR with high priority, a PUCCH for the positive SR with high priority is transmitted, and the PUCCH for periodic/semi-persistent CSI with normal BLER requirements is dropped or punctured.

In one implementation, when a PUCCH is configured for periodic/semi-persistent CSI with ultra-reliability requirements with PUCCH format 2 or PUCCH format 3 or PUCCH format 4, a UE may count all SR configurations (e.g., a total number (K₃) of SRs with all priority configurations (e.g., high and low priority configurations)), whose PUCCH resources overlap with the PUCCH resource for periodic/semi-persistent CSI with ultra-reliability requirements with PUCCH format 2 or PUCCH format 3 or PUCCH format 4 in the slot; append SR information bits (e.g., by multiplexing) to periodic/semi-persistent CSI information bits using PUCCH format 2 or PUCCH format 3 or PUCCH format 4, where the number of the SR information bits is obtained by O_{SR}=ceil(log₂(K₃+1)); and transmit combined uplink control information (UCI) bits, having the periodic/semi-persistent CSI information bits and the SR information bits, in a PUCCH using the PUCCH resource for the periodic/semi-persistent CSI information bits with PUCCH format 2 or PUCCH format 3 or PUCCH format 4. Also, the index of the positive SR with the highest priority is reported, and an all-zero value for the appended SR bits represents a negative SR value across all overlapping SRs. Special handling methods are defined under certain timing constraints. In general, an SR with high priority has a higher priority than that of a CSI. If the CSI and SR multiplexing cannot be performed, the PUCCH for a positive SR with high priority should be transmitted and the PUCCH for CSI may be dropped or punctured.

In one implementation, when a PUCCH is configured for periodic/semi-persistent CSI with ultra-reliability requirements (e.g., BLER being 10\hat{ }−5 or less) with PUCCH format 2 or PUCCH format 3 or PUCCH format 4, a UE may count only SR with high priority configurations (e.g., a total number (K₄) of SRs with high priority configurations, ignoring SR with low priority configurations), whose PUCCH resources overlap with the PUCCH resource for periodic/semi-persistent CSI with ultra-reliability requirements with PUCCH format 2 or PUCCH format 3 or PUCCH format 4 in the slot; append SR information bits (e.g., by multiplexing) to periodic/semi-persistent CSI information bits using PUCCH format 2 or PUCCH format 3 or PUCCH format 4, where the number of the SR information bits is obtained by O_{SR}=ceil(log₂(K₄+1)); and transmit combined uplink control information (UCI) bits, having the periodic/semi-persistent CSI information bits and the SR information bits, in a PUCCH using the PUCCH resource for the periodic/semi-persistent CSI information bits with PUCCH format 2 or PUCCH format 3 or PUCCH format 4. Also, the index of the positive SR with the highest priority is reported, and an all-zero value for the appended SR bits represents a negative SR value across all overlapping SRs with high priority. Special handling methods are defined under certain timing constraints. In general, an SR with high priority has a higher priority than that of a CSI. If the CSI and SR multiplexing cannot be performed, the PUCCH for a positive SR with high priority should be transmitted and the PUCCH for CSI may be dropped or punctured.

The existing UE procedure for SR reporting is described below.

In Subclause 9.2.4 of TS 38.213 in Rel-15 of the 3GPP specification, UE procedure for reporting SR is provided, the content of Subclause 9.2.4 of TS 38.213 in Rel-15 is incorporated by reference in its entirety. A UE is configured by a higher layer parameter, SchedulingRequestResourceConfig, a set of configurations for SR in a PUCCH transmission using either PUCCH format 0 or PUCCH format 1. The UE is configured a PUCCH resource by higher layer parameter SchedulingRequestResourceId providing a PUCCH format 0 resource or a PUCCH format 1 resource as described in Subclause 9.2.1 in TS 38.213. The UE is also configured a periodicity SR_{PERIODICITY} in symbols or slots and an offset SR_{OFFSET} in slots by higher layer parameter periodicityAndOffset for a PUCCH transmission conveying SR. If SR_{PERIODICITY} is larger than one slot, the UE determines SR transmission occasion in a PUCCH to be in a slot with number n_{s,f}^{μ} [TS 38.211] in a frame with number n_{f} if (n_{f}·Nₛₗₒₜ^{frame,μ}+n_{s,f}^{μ}−SR_{OFFSET})mod SR_{PERIODICITY}=0.

If SR_{PERIODICITY} is one slot, the UE expects that SR_{OFFSET}=0 and every slot is SR transmission occasion in a PUCCH.

If SR_{PERIODICITY} is smaller than one slot, the UE determines SR transmission occasion in a PUCCH to start in a symbol with index l [TS 38.211] if (l−l₀ mod SR_{PERIODICITY})mod SR_{PERIODICITY}=0 where l₀ is the value of higher layer parameter startingSymbolIndex.

If the UE determines that, for SR transmission occasion in a PUCCH, the number of symbols available for the PUCCH transmission in a slot is smaller than the value provided by higher layer parameter nrofSymbols, the UE does not transmit the PUCCH in the slot.

SR transmission occasions in a PUCCH are subject to the limitations for UE transmissions described in Subclause 11.1 and Subclause 11.1.1 of TS38.213.

The UE transmits a PUCCH in the PUCCH resource for the corresponding SR configuration only when the UE transmits a positive SR. For a positive SR transmission using PUCCH format 0, the UE transmits the PUCCH as described in [TS 38.211] by obtaining m₀ as described for HARQ-ACK information in Subclause 9.2.3 of TS 38.213 and by setting m_{cs}=0. For a positive SR transmission using PUCCH format 1, the UE transmits the PUCCH as described in [TS 38.211] by setting b(0)=0.

In Subclause 9.2.5.1 of TS 38.213 in Rel-15 of the 3GPP specification, UE procedure for multiplexing HARQ-ACK or CSI and SR in a PUCCH is provided, the content of Subclause 9.2.5.1 of TS 38.213 in Rel-15 is incorporated by reference in its entirety. A UE is configured to transmit K PUCCHs for respective K SRs in a slot, as determined by a set of higher layer parameters schedulingRequestResourceId, with SR transmission occasions that would overlap with a transmission of a PUCCH with HARQ-ACK information from the UE in the slot or with a transmission of a PUCCH with periodic/semi persistent CSI transmission from the UE in the slot.

If a UE would transmit a PUCCH with HARQ-ACK information bits in a resource using PUCCH format 2 or PUCCH format 3 or PUCCH format 4 in a slot, as described in Subclause 9.2.3, ┌ log₂(K+1)┐ bits representing a negative or positive SR, in ascending order of the values of schedulingRequestResourceId, are appended to the HARQ-ACK information bits, and the UE transmits the combined UCI bits in a PUCCH using a resource with PUCCH format 2 or PUCCH format 3 or PUCCH format 4 for transmission of HARQ-ACK information bits. An all-zero value for the ┌ log₂(K+1)┐ bits represents a negative SR value across all K SRs.

If a UE would transmit a PUCCH with periodic/semi-persistent CSI in a resource using PUCCH format 2 or PUCCH format 3 or PUCCH format 4 in a slot, ┌ log₂(K+1)┐ bits representing corresponding negative or positive SRs, in ascending order of the values of schedulingRequestResourceId, are prepended to the periodic/semi-persistent CSI information bits as described in Subclause 9.2.5.2 and the UE transmits a PUCCH with the combined UCI bits in a resource using the PUCCH format 2 or PUCCH format 3 or PUCCH format 4 for CSI reporting. An all-zero value for the ┌ log₂(K+1)┐ bits represents a negative SR value across all K SRs.

If a UE transmits a PUCCH with O_{ACK} HARQ-ACK information bits, O_{SR}=┌ log₂(K+1)┐ SR bits, and O_{CRC} CRC bits using PUCCH format 2 or PUCCH format 3 in a PUCCH resource that includes M_{RB}^{PUCCH} PRBs, the UE determines a number of PRBs M_{RB,min}^{PUCCH} for the PUCCH transmission to be the minimum number of PRBs, that is smaller than or equal to a number of PRBs provided respectively by higher layer parameter nrofPRBs in PUCCH-format2 or nrofPRBs in PUCCH-format3 and starts from the first PRB from the number of PRBs, that results to (O_{ACK}+O_{SR}+O_{CRC})≤M_{RB,min}^{PUCCH}·N_{sc,ctrl}^{RB}·N_{symb-UCI}^{PUCCH}·Qₘ·r and, if M_{RB}^{PUCCH}>1, (O_{ACK}+O_{SR}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}, N_{symb-UCI}^{PUCCH}, Qₘ, and r are defined in Subclause 9.2.5.2. If (O_{ACK}+O_{SR}+O_{CRC})>(M_{RB,min}^{PUCCH}−1)·N_{sc,ctrl}^{RB}·N_{symb-UCI}^{PUCCH}·Qₘ·r, the UE transmits the PUCCH over the M_{RB}^{PUCCH} PRBs.

In the current 3GPP specification, multiple SR configurations may be configured for a UE. Each SR configuration may be linked to a different traffic type or service. An SR configuration may include an SR PUCCH format and resource, a periodicity and an offset within the periodicity. Since SR only carries one bit, an SR PUCCH resource may be configured with PUCCH format 0 or PUCCH format 1.

In the next generation (e.g., 5G NR) wireless communication networks, different service types are supported, (e.g., enhanced mobile broadband (eMBB) and ultra-reliable and low latency (URLLC)). In various implementations of the present application, at least two HARQ-ACK codebooks may be simultaneously constructed for different service types.

For example, Radio Network Temporary Identifier (RNTI) and/or downlink control information (DCI) in downlink (DL) assignment may be used for identifying PDSCHs for different service types (e.g., an eMBB PDSCH and a URLLC PDSCH). In another example, RNTI and/or DCI in DL assignment may be used for identifying HARQ-ACK codebooks for different service types (e.g., a slot level or a slot-based HARQ-ACK codebook for an eMBB PDSCH, a subslot level or sub-slot-based HARQ-ACK codebook for a URLLC service type, etc.).

In various implementations of the present application, prioritization (e.g., lower priority and higher priority) is supported for PUSCH transmission for different service types. For example, RNTI and/or DCI in UL grant may be used for identifying PUSCHs for different service types (e.g., an eMBB PUSCH and a URLLC PUSCH).

With different service types, separate period/semi-persistent CSI report for URLLC may be supported. Especially, for URLLC, the MCS setting can have different BLER targets, thus, the feedback of CSI may also be different based on different BLER targets. Thus, the periodicity for URLLC CSI report may be shorter than that of eMBB service type, and the PUCCH for the CSI feedback may also require ultra-reliability.

Furthermore, NR supports that the SR priority is known at PHY layer.

In Rel-15, there is no priority differentiation for either periodic/semi-persistent CSI or SR. With separate periodic/semi-persistent CSI for different service types and known SR priority at PHY layer, the SR transmission, especially SR multiplexing with other UCI need to be enhanced based on the CSI type and SR priorities.

In various implementations of the present application, the case of SR multiplexing with periodic/semi-persistent CSI on PUCCH format 2, 3, and 4 is investigated, and several novel methods to differentiate SR priority while considering periodic/semi-persistent CSI for different service types and BLER targets are demonstrated.

In the following, the methods for determining an SR priority are described. The SR priority is known at the physical layer. At least two levels of SR priority should be defined, namely high priority and low priority.

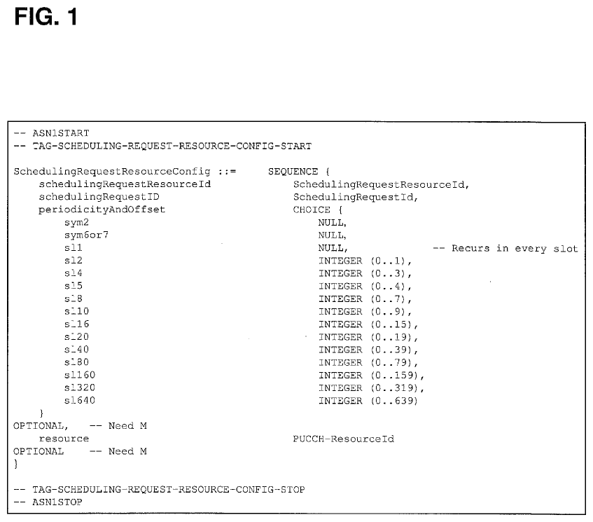

In various implementations of the present application, SR priority may be determined based on the periodicity in the SR resource configuration. FIG. 1 shows a SchedulingRequestResourceConfig information element (IE). The SchedulingRequestResourceConfig IE determines physical layer resources on PUCCH where the UE may send the dedicated scheduling request (D-SR) (see TS38.213, section 9.2.4).

SchedulingRequestResourceConfig field descriptions

periodicityAndOffset
SR periodicity and offset in number of slots. Corresponds to L1 parameter ‘SR-periodicity’ and
‘SR-offset’
(see 38.213, section 9.2.2). The following periodicities may be configured depending on the
chosen subcarrier spacing:
SCS = 15 kHz: 2sym, 7sym, 1sl, 2sl, 4sl, 5sl, 8sl, 10sl, 16sl, 20sl, 40sl, 80sl
SCS = 30 kHz: 2sym, 7sym, 1sl, 2sl, 4sl, 8sl, 10sl, 16sl, 20sl, 40sl, 80sl, 160sl
SCS = 60 kHz: 2sym, 7sym/6sym, 1sl, 2sl, 4sl, 8sl, 16sl, 20sl, 40sl, 80sl, 160sl, 320sl
SCS = 120 kHz: 2sym, 7sym, 1sl, 2sl, 4sl, 8sl, 16sl, 40sl, 80sl, 160sl, 320sl, sl640
sym6or7 corresponds to 6 symbols if extended cyclic prefix and a SCS of 60 kHz are
configured,
otherwise it corresponds to 7 symbols.
For periodicities sym2, sym7 and sl1 the UE assumes an offset of 0 slots.
resource
ID of the PUCCH resource in which the UE shall send the scheduling request. The actual
PUCCH-Resource is
configured in PUCCH-Config of the same UL BWP and serving cell as this
SchedulingRequestResourceConfig.
The network configures a PUCCH-Resource of PUCCH-format0 or PUCCH-format1 (other
formats not supported).
Corresponds to L1 parameter ‘SR-resource’ (see 38.213, section 9.2.2)
schedulingRequestID
The ID of the SchedulingRequestConfig that uses this scheduling request resource.

In one example method according to an implementation of the present application, SR priority may be determined based on the number of symbols. The UE is configured a periodicity SR_{PERIODICITY} in symbols or slots and an offset SR_{OFFSET} in slots by higher layer parameter periodicityAndOffset for a PUCCH transmission conveying SR. A threshold value of a number of symbols can be specified to determine the SR priority. The threshold value may be fixed in the specification. The threshold value may be configured by higher layer signaling (e.g., RRC signaling). A set of values may be configured, and the index of the configured value may be indicated to UE.

For example, if SR_{PERIODICITY} is larger than or equal to one slot, the SR is an SR with low priority. If SR_{PERIODICITY} is smaller than one slot, e.g. 2 symbols, 6 or 7 symbols, the SR is an SR with high priority.

However, for a high sub-carrier spacing (SCS) setting, a PUCCH with one slot or more can still be very short. In such a case, the threshold may be specified/configured depending on each SCS. The UE may determine the threshold value based on the SCS configured for uplink (UL) bandwidth part (BWP) for SR transmission (e.g., a UL BWP where a PUCCH resource configured for SR is configured).

In another example method according to an implementation of the present application, SR priority may be determined based on time duration. For example, the SR priority may be determined based on the PUCCH duration of the SR resource. For example, when the SR periodicity (e.g., SR_{PERIODICITY}) is less than or equal to 0.5 ms (Periodicity≤0.5 ms), the SR may be considered as an SR with high priority. In other examples, the periodicity may also be defined based on the number of symbols.

A threshold value of a time duration can be specified to determine the SR priority. In one example, the threshold value may be fixed in the specification. In another example, the threshold value may be configured by higher layer signaling (e.g., RRC signaling). In yet another example, a set of values may be configured, and one or more indices of the corresponding one or more configured values may be indicated to the UE.

For example, if the SR PUCCH duration is greater than 0.5 ms (or 0.25 ms), the SR is an SR with low priority. When the SR periodicity (e.g., SR_{PERIODICITY}) is less than or equal to 0.5 ms (or 0.25 ms), the SR may be considered as an SR with high priority. Thus, for different high SCS settings, the number of symbols and slots can be different for an SR to be classified into an SR with high priority. For example, for a SCS of 60 kHz, an SR having a periodicity (e.g., SR_{PERIODICITY}) of 1 or 2 slots can still be considered an SR with high priority.

In yet another example method according to an implementation of the present application, SR priority may be indicated by higher layer signaling. For example, an SR priority may be explicitly indicated in an SR configuration. The SR priority may be determined based on the parameters in an SR PUCCH configuration. For example, an SR with high priority may be configured with enhanced PUCCH formats (e.g., more than one RB allocation, high transmit power, multiple sequences or cyclic shifts associated with one SR PUCCH resource).

For SR with low priority, only one resource is configured with a sequence and a cyclic shift. Thus, up to twelve SR resources may be configured within one resource block (RB) with the same sequence and different cyclic shifts. An SR with high priority may be configured with a sequence and a cyclic shift, but multiple cyclic shifts associated with the given cyclic shift may be reserved. For example, the configured cyclic shift plus 3, 6, 9 may be reserved and not assigned to any other SRs or PUCCHs in the same physical resource block (PRB). Thus, up to 3 SR with high priority may be configured in a RB with the same sequence and different cyclic shifts. And, an SR with high priority is essentially configured with multiple cyclic shift resources.

In some implementations of the present application, SR priority may be limited to two general categories (or levels), a first priority or high priority, and a second priority or low priority. Furthermore, multiple levels of priorities within each category may be further specified. For example, for different URLLC services, different SR configurations within the SR with high priority category may be applied.

Currently, a PUCCH for periodic/semi-persistent CSI is configured with a periodicity in a number of slots. In existing 3GPP standard, the same method as PUCCH format 2, 3, or 4 for HARQ-ACK is used for collision between SR and a PUCCH with periodic/semi-persistent CSI in a resource using PUCCH format 2 or PUCCH format 3 or PUCCH format 4 in a slot.

For example, a UE is configured to transmit K PUCCHs for respective K SRs in a slot, as determined by a set of higher layer parameters schedulingRequestResourceId, with SR transmission occasions that would overlap with a transmission of a PUCCH with HARQ-ACK information from the UE in the slot or with a transmission of a PUCCH with periodic/semi persistent CSI transmission from the UE in the slot.

If a UE would transmit a PUCCH with periodic/semi-persistent CSI in a resource using PUCCH format 2 or PUCCH format 3 or PUCCH format 4 in a slot, ┌ log₂(K+1)┐ in bits representing corresponding negative or positive SRs, in ascending order of the values of schedulingRequestResourceId, are prepended to the periodic/semi-persistent CSI information bits as described in Subclause 9.2.5.2 and the UE transmits a PUCCH with the combined UCI bits in a resource using the PUCCH format 2 or PUCCH format 3 or PUCCH format 4 for CSI reporting. An all-zero value for the ┌ log₂(K+1)┐ bits represents a negative SR value across all K SRs.

Currently in NR, the PUCCH resource for periodic/semi-persistent CSI are configured with a periodicity in a number of slots. There has not been consideration for separate CSI configurations for different service types.

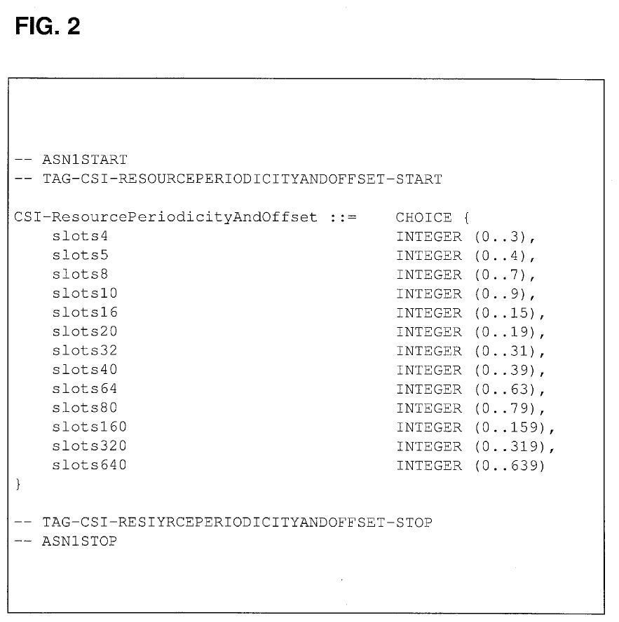

In various implementations of the present application, the IE CSIResourcePeriodicityAndOffset is used to configure a periodicity and a corresponding offset for periodic and semi-persistent CSI resources, and for periodic and semi-persistent reporting on PUCCH. FIG. 2 shows a CSI-ResourcePeriodicityAndOffset information element. As shown in FIG. 2, both the periodicity and offset are given in number of slots. The periodicity value “slots4” corresponds to 4 slots, “slots5” corresponds to 5 slots, and so on.

In accordance with various implementations of the present application, enhancements to PUCCH configuration for periodic/semi-persistent CSI reporting are provided.

In NR, different service types, such as eMBB and URLLC, are supported. To support different service types (e.g., URLLC), the PUCCH configuration for periodic/semi-persistent CSI may be enhanced with shorter periodicity and/or higher reliability requirements.

According to one exemplary method of the present application, the periodicity for periodic/semi-persistent CSI PUCCH resource for a service type (e.g., URLLC traffic) may still be at slot level with a smaller number of slots. For example, the periodicity can be reduced to 1 slot or 2 slots from the minimum 4 slots in the current specification.

According to one exemplary method of the present application, the periodicity for periodic/semi-persistent CSI PUCCH resource for a service type (e.g., URLLC traffic) may be defined in a number of subslots instead of slots. A subslot structure should be defined at least for PUCCH configuration of URLLC HARQ-ACK bits, for example, for the subslot based HARQ-ACK codebook. The same subslot structure may be used to define the periodicity of a PUCCH configuration for periodic/semi-persistent CSI of URLLC.

Among other advantages, reduced periodicity for periodic/semi-persistent CSI reports can provide timely and more accurate channel estimation for the URLLC traffic.

In addition, the error probability for the CSI report for different service types can be configured separately or jointly.

According to one exemplary method of the present application, the BLER requirement for a periodic/semi-persistent CSI PUCCH resource for URLLC traffic may still be the same as existing CSI reports for eMBB (e.g., 10\hat{ }−2).

According to another exemplary method of the present application, the BLER requirement for a periodic/semi-persistent CSI PUCCH resource for URLLC traffic may be enhanced with a much lower target (e.g., 10\hat{ }−4 or 10\hat{ }−5). This provides more reliable feedback with the tradeoff or higher PUCCH channel overhead.

If the PUCCH for periodicity for periodic/semi-persistent CSI of URLLC traffic is configured at subslot level, or with a much lower BLER requirement, the PUCCH for periodicity for periodic/semi-persistent CSI of URLLC service type need to be configured separately from the PUCCH for periodicity for periodic/semi-persistent CSI of eMBB service type.

In the following, several methods of reporting CSI and SR are described when at least one PUCCH resource configured for SR overlaps with a PUCCH resource configured for CSI with 2 or more bits with PUCCH format 2 or PUCCH format 3 or PUCCH format 4.

If the PUCCH resource for a periodic/semi-persistent CSI is configured with PUCCH format 2, the PUCCH is a short PUCCH with only one or two symbols. The duration of the PUCCH for the periodic/semi-persistent CSI is the same as or shorter than the subslot duration. In such a case, it can be assumed that the status of all SRs overlap with the PUCCH for the periodic/semi-persistent CSI is known.

There are potential issues if there is at least one SR with high priority in the K SRs that overlap with the PUCCH resource for the periodic/semi-persistent CSI configured with long PUCCH formats (e.g., PUCCH format 3 and 4). First of all, an SR with high priority may come late, and the SR status is not known when the PUCCH for the periodic/semi-persistent CSI transmission starts. Secondly, there may be different positive high priorities SRs in different subslots, the current method can only indicate one SR, some of the SR with high priority may be dropped. Thirdly, an SR with high priority may be time sensitive and requires low latency, if it is multiplexed on the PUCCH for the periodic/semi-persistent CSI, the delay tolerance may be exceeded and not acceptable. Furthermore, the BLER requirements of a periodic/semi-persistent CSI may be very different from that of an SR with high priority. For example, the target detection error of periodic/semi-persistent CSI or AN SR with low priority on PUCCH may be 10\hat{ }−2. But, the target detection error for an SR with high priority may be 10\hat{ }−5. In such a case, append extra bits for SR on a PUCCH for periodic/semi-persistent CSI may not be able to provide the desirable performance for SR with high priority.

Thus, if the SR with high priority is more important than the periodic/semi-persistent CSI, the transmission of a PUCCH for an SR with high priority should have a higher priority than a PUCCH for a periodic/semi-persistent CSI.

According to various implementations of the present application, the HARQ-ACK and SR for the same service type should have the same or similar priority. The CSI should have a lower priority than HARQ-ACK and SR, at least for the same service type. Thus, SR multiplexing with CSI may be applied when possible if the SR and CSI have similar BLER targets. However, if the BLER target for a positive SR is much lower than the BLER target of a CSI report, then the PUCCH for SR should have a higher priority than the PUCCH for CSI.

Therefore, different handling methods may be used for SR multiplexing with CSI on a PUCCH while considering different reliability and priority requirements between the UCI types and SR priorities.

Case 1: PUCCH for Periodic/Semi-Persistent CSI with Normal BLER Requirements

In various implementations of the present application, a PUCCH for periodic/semi-persistent CSI with normal BLER requirements may be configured for different service types (e.g., eMBB and URLLC). For eMBB service type traffic, the existing periodic/semi-persistent CSI report and PUCCH configurations may be sufficient. For URLLC service type traffic, the periodic/semi-persistent CSI report may be configured with shorter periodicity with normal BLER requirements. Since the CSI is reported more often for URLLC, the reliability requirements may be relaxed.

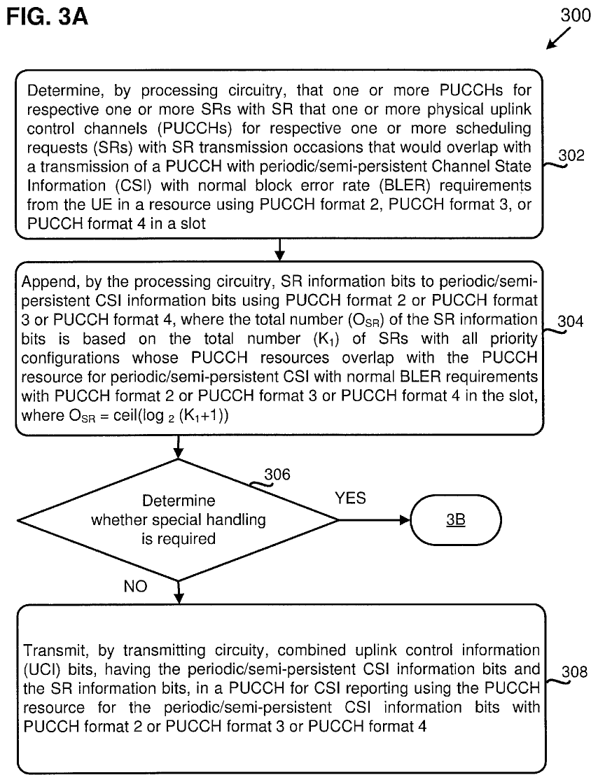

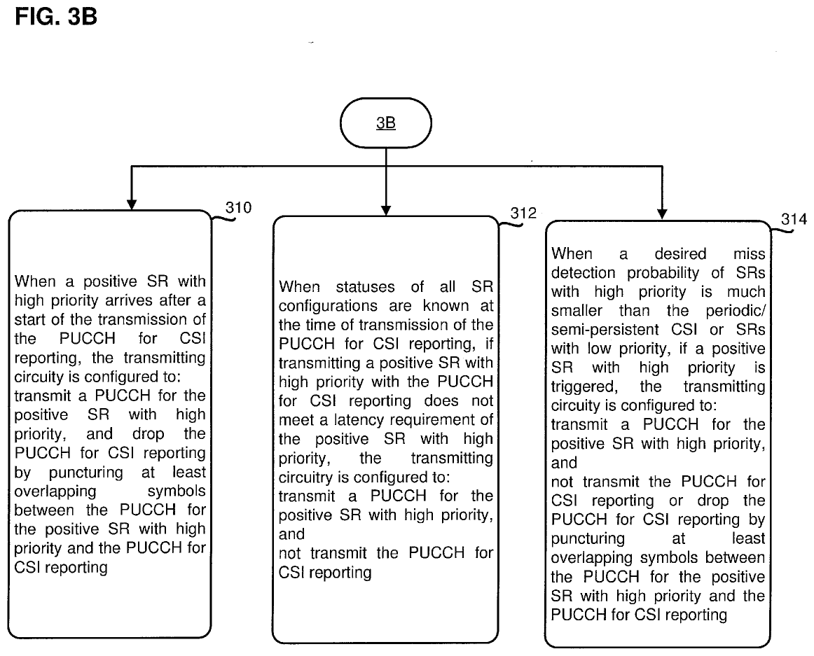

FIGS. 3A and 3B are a flowchart diagram illustrating a method of a UE for handling SRs with all priorities and CSI having similar BLER (normal) requirements, in accordance with example implementations of the present application. In the exemplary method shown in FIGS. 3A and 3B, the UE may count all SRs with all priority configurations whose PUCCH resources overlap with the PUCCH resource for periodic/semi-persistent CSI with normal BLER requirements with PUCCH format 2 or PUCCH format 3 or PUCCH format 4 in the slot. As shown in FIGS. 3A and 3B, flowchart 300 includes actions 302, 304, 306, 308, 310, 312, and 314.

In action 302, the UE may determine, by processing circuitry, that one or more physical uplink control channels (PUCCHs) for respective one or more scheduling requests (SRs) with SR transmission occasions that would overlap with a transmission of a PUCCH with periodic/semi-persistent Channel State Information (CSI) with normal block error rate (BLER) requirements from the UE in a resource using PUCCH format 2, PUCCH format 3, or PUCCH format 4 in a slot.

In action 304, the UE may append, by the processing circuitry, SR information bits to periodic/semi-persistent CSI information bits using PUCCH format 2 or PUCCH format 3 or PUCCH format 4, where the total number (O_{SR}) of the SR information bits is based on the total number (K₁) of SRs with all priority configurations whose PUCCH resources overlap with the PUCCH resource for periodic/semi-persistent CSI with normal BLER requirements with PUCCH format 2 or PUCCH format 3 or PUCCH format 4 in the slot. For example, the total number (O_{SR}) of the SR information bits may be obtained by O_{SR}=┌ log₂(K₁+1)┐=ceil(log₂(K₁+1)). In action 304, the UE may multiplex the SRs with CSI. In case of at least one positive SR is triggered, an index of a positive SR with the highest priority is reported by the SR information bits. Also, an all-zero value for the number (O_{SR}) of the SR information bits represents a negative SR value across all overlapping SRs.

In action 306, the UE may determine if special handling is required. If special handling is required, flowchart 300 may proceed to actions 310, 312, and 314 in FIG. 3B. The conditions for special handling may be based on timing restrictions and/or detection error probability requirements (e.g., BLER requirements). If special handling is not required, flowchart 300 may proceed to action 308.

In action 308, if no special handling is needed, the UE may transmit, by transmitting circuitry, combined uplink control information (UCI) bits, having the periodic/semi-persistent CSI information bits (e.g., corresponding to CSI with normal BLER requirements) and the SR information bits, in a PUCCH for CSI reporting using the PUCCH resource for the periodic/semi-persistent CSI information bits (e.g., with normal BLER requirements) with PUCCH format 2 or PUCCH format 3 or PUCCH format 4.

When special handling is required as determined in action 306, flowchart 300 may proceed to actions 310, 312, and 314 in FIG. 3B.

In action 310, when a positive SR with high priority arrives after a start of the transmission of the PUCCH for CSI reporting, the transmitting circuitry is configured to transmit a PUCCH for the positive SR with high priority, and drop the PUCCH for CSI reporting by puncturing at least overlapping symbols between the PUCCH for the positive SR with high priority and the PUCCH for CSI reporting.

In action 312, if statuses of all SR configurations are known at the time of transmission of the PUCCH for CSI reporting, and if transmitting a positive SR with high priority with the PUCCH for CSI reporting does not meet a latency requirement of the positive SR with high priority, the transmitting circuitry is configured to transmit a PUCCH for the positive SR with high priority, and not transmit the PUCCH for CSI reporting.

In action 314, if a desired miss detection probability of SRs with high priority is much lower than the periodic/semi-persistent CSI or SRs with low priority, if a positive SR with high priority is triggered, the transmitting circuitry is configured to transmit a PUCCH for the positive SR with high priority, and not transmit the PUCCH for CSI reporting or drop the PUCCH for CSI reporting by puncturing at least overlapping symbols between the PUCCH for the positive SR with high priority and the PUCCH for CSI reporting.

In the present exemplary method, the UE would transmit a PUCCH with periodic/semi-persistent CSI in a resource using PUCCH format 2 or PUCCH format 3 or PUCCH format 4 in a slot, ┌ log₂(K₁+1)┐ bits representing corresponding a negative or positive SR, in ascending order of the values of schedulingRequestResourceId, are prepended to the periodic/semi-persistent CSI information bits and the UE transmits a PUCCH with the combined UCI bits in a resource using the PUCCH format 2 or PUCCH format 3 or PUCCH format 4 for CSI reporting.

The index of the positive SR with the highest priority is reported by the ┌ log₂(K₁+1)┐ bits. An all-zero value for the ┌ log₂(K₁+1)┐ bits represents a negative SR value across all K₁ SRs.

In various implementations of the present exemplary method, special handling with timing constraints still need to be specified. Even if the BLER performance is acceptable, under some timing constraints, certain special handling methods are still needed. The status of all SRs is assumed to be known for this approach, but the status of an SR with high priority may depend on when the positive SR is triggered. The status of the SR may be further limited by the processing time applied for different service types.

In one implementation according to the present exemplary method, if a positive SR with high priority arrives after the start of the transmission of the PUCCH for periodic/semi-persistent CSI, the positive SR with high priority cannot be reported together with the periodic/semi-persistent CSI. In such a case, the PUCCH for the positive SR with high priority should be transmitted, and the PUCCH for periodic/semi-persistent CSI should be punctured by the PUCCH for the positive SR with high priority at least in the overlapping symbols. If there are remaining symbol(s) on the PUCCH for periodic/semi-persistent CSI transmission, in one approach, the remaining symbol(s) on the PUCCH for periodic/semi-persistent CSI transmission are also dropped. In another approach, the remaining symbol(s) on the PUCCH for periodic/semi-persistent CSI transmission are resumed and still transmitted.

In another implementation according to the present exemplary method, even if a positive SR with high priority is multiplexed with the periodic/semi-persistent CSI, if the end of the PUCCH for periodic/semi-persistent CSI is too late for a positive SR with high priority, the latency requirement may not be satisfied for an ultra-reliable and low-latency traffic. In this case, the PUCCH for the positive SR with high priority should be transmitted, and the PUCCH for periodic/semi-persistent CSI should be dropped and not transmitted.

In yet another implementation according to the present exemplary method, if the desired miss detection probability of SR with high priority is much lower than the periodic/semi-persistent CSI or SR with low priority (or if the SR with high priority is configured with an ultra-reliable PUCCH resource), the transmission of a PUCCH for a positive SR with high priority should have a higher priority than a PUCCH for a periodic/semi-persistent CSI. For example, the desired miss detection probability of SR with high priority may be at least one order of magnitude lower than the periodic/semi-persistent CSI or SR with low priority. In another example, the desired miss detection probability of SR with high priority may be less than an order of magnitude lower than the periodic/semi-persistent CSI or SR with low priority. Thus, even if the SRs with all priorities can be multiplexed with the periodic/semi-persistent CSI, if a positive SR with high priority is triggered, the PUCCH for the positive SR with high priority should be transmitted, and the PUCCH for periodic/semi-persistent CSI multiplexed with SR should be dropped or punctured.

As discussed above, a PUCCH for a positive SR with high priority should be transmitted anyway in several cases based on timing constraints or BLER performance criteria. Thus, there is no need to count SRs with high priority into the SR multiplexing with periodic/semi-persistent CSI with normal BLER requirements.

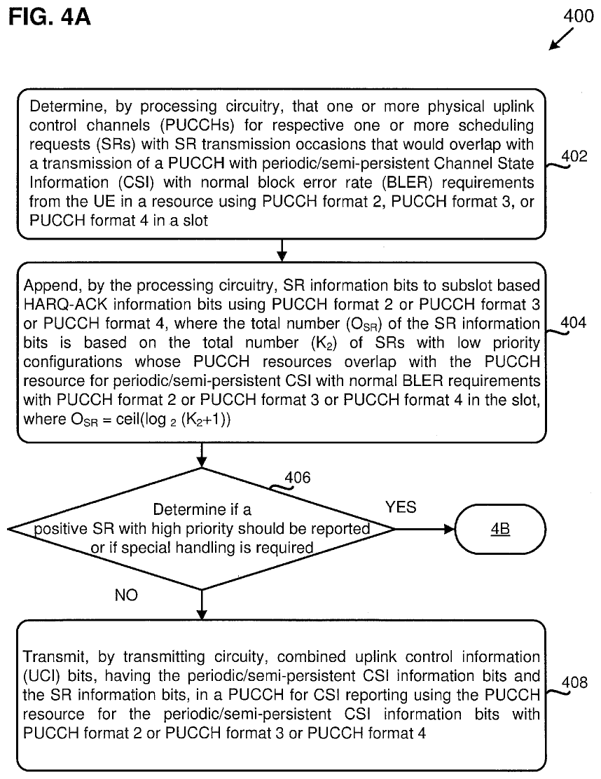

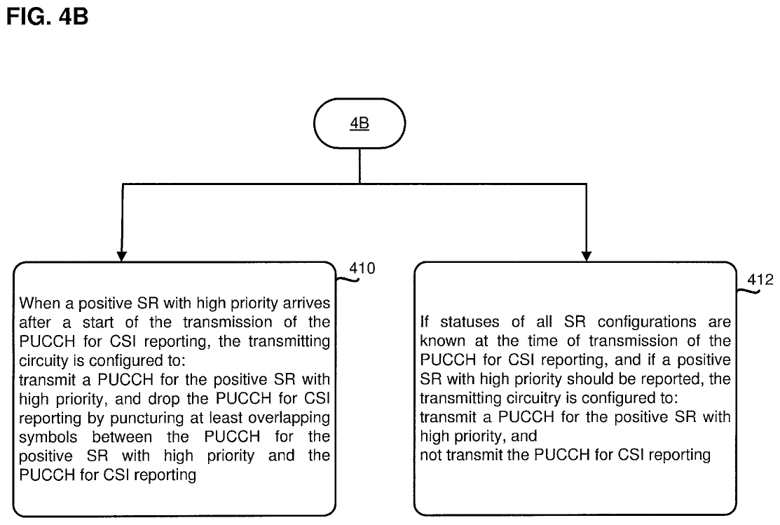

FIGS. 4A and 4B are a flowchart diagram illustrating a method of a UE for handling SRs with all priorities with SR differentiation by multiplexing low priority SR and CSI having similar BLER (normal) requirements, in accordance with example implementations of the present application. In the exemplary method shown in FIGS. 4A and 4B, only SRs with low priority are multiplexed with CSI having similar BLER targets. In the present implementation, the UE may count only SRs with low priority whose PUCCH resources overlap with the PUCCH resource for periodic/semi-persistent CSI with normal BLER requirements with PUCCH format 2 or PUCCH format 3 or PUCCH format 4 in the slot. As shown in FIGS. 4A and 4B, flowchart 400 includes actions 402, 404, 406, 408, 410, and 412.

In action 402, the UE may determine, by processing circuitry, that one or more physical uplink control channels (PUCCHs) for respective one or more scheduling requests (SRs) with SR transmission occasions that would overlap with a transmission of a PUCCH with periodic/semi-persistent Channel State Information (CSI) with normal block error rate (BLER) requirements from the UE in a resource using PUCCH format 2, PUCCH format 3, or PUCCH format 4 in a slot.

In action 404, the UE may append, by the processing circuitry, SR information bits to periodic/semi-persistent CSI information bits using PUCCH format 2 or PUCCH format 3 or PUCCH format 4, where the total number (O_{SR}) of the SR information bits is based on the total number (K₂) of SRs with low priority configurations whose PUCCH resources overlap with the PUCCH resource for periodic/semi-persistent CSI with normal BLER requirements with PUCCH format 2 or PUCCH format 3 or PUCCH format 4 in the slot. For example, the total number (O_{SR}) of the SR information bits may be obtained by O_{SR}=ceil(log₂(K₂+1))=┌ log₂(K₂+1)┐. In action 404, the UE may multiplex the SRs with low priority configurations with CSI, and ignore SRs with high priority configurations irrespective of whether the SRs with high priority are positive or negative. In case of at least one positive SR is triggered, an index of a positive SR with the highest priority is reported by the SR information bits. Also, an all-zero value for the number (O_{SR}) of the SR information bits represents a negative SR value across all overlapping SRs.

In action 406, the UE may determine if a positive SR with high priority should be reported or if special handling is required. If a positive SR with high priority should be reported or special handling is required, flowchart 400 may proceed to actions 410 and 412 in FIG. 4B. If special handling is not required, flowchart 400 may proceed to action 408.

In action 408, the UE may transmit, by transmitting circuitry, combined uplink control information (UCI) bits, having the periodic/semi-persistent CSI information bits (e.g., corresponding to CSI with normal BLER requirements) and the SR information bits, in a PUCCH for CSI reporting using the PUCCH resource for the periodic/semi-persistent CSI information bits with PUCCH format 2 or PUCCH format 3 or PUCCH format 4.

When a positive SR with high priority should be reported or if special handling is required as determined in action 406, flowchart 400 may proceed to actions 410 and 412 in FIG. 4B. In action 410, for special handling, when a positive SR with high priority arrives after a start of the transmission of the PUCCH for CSI reporting, the transmitting circuitry is configured to transmit a PUCCH for the positive SR with high priority, and drop the PUCCH for CSI reporting by puncturing at least overlapping symbols between the PUCCH for the positive SR with high priority and the PUCCH for CSI reporting. In action 412, if statuses of all SR configurations are known at the time of transmission of the PUCCH for CSI reporting, and if a positive SR with high priority should be reported, the transmitting circuitry is configured to transmit a PUCCH for the positive SR with high priority, and not transmit the PUCCH for CSI reporting.

In the exemplary method shown in FIGS. 4A and 4B, to differentiate the SR priority, periodic/semi-persistent CSI and SR multiplexing is performed based on priorities. Thus, SRs with high priority are not multiplexed with periodic/semi-persistent CSI with normal BLER requirements, and only SRs with low priority are counted in SR payload appended to periodic/semi-persistent CSI with normal BLER requirements. The SRs with high priority are not reported together with the periodic/semi-persistent CSI with normal BLER requirements. Instead, channel dropping based on priority is performed. Thus, if a positive SR with high priority is triggered, the PUCCH for the positive SR with high priority is transmitted, and the PUCCH for periodic/semi-persistent CSI with normal BLER requirements should be dropped or punctured.

In the present exemplary method, the UE is configured to transmit K21 PUCCHs for respective K₂ SRs with low priorities in a slot, as determined by a set of higher layer parameters schedulingRequestResourceId, with the SR with low priority transmission occasions that would overlap with a transmission of a PUCCH with periodic/semi persistent CSI transmission from the UE in the slot.

In the present exemplary method, if the UE would transmit a PUCCH with periodic/semi-persistent CSI information bits with normal BLER requirements in a resource using PUCCH format 2 or PUCCH format 3 or PUCCH format 4 in a slot, ┌ log₂(K₂+1)┐ bits representing a negative or positive SR with low priority, in ascending order of the values of schedulingRequestResourceId, are appended to the periodic/semi-persistent CSI information bits and the UE transmits the combined UCI bits in a PUCCH using a resource with PUCCH format 2 or PUCCH format 3 or PUCCH format 4 for transmission of periodic/semi-persistent CSI information bits. An all-zero value for the ┌ log₂(K₂+1)┐ bits represents a negative SR value across all K₂ SRs with low priority.

In the present exemplary method, if the UE would transmit a PUCCH with periodic/semi-persistent CSI information bits with normal BLER requirements in a resource using PUCCH format 2 or PUCCH format 3 or PUCCH format 4 in a slot, and overlaps with a positive SR with high priority transmission occasion, the UE transmits a PUCCH in the PUCCH resource for the corresponding positive SR with high priority. The PUCCH of positive SR with the highest priority is transmitted if there are multiple positive SRs with high priority or low priorities. The PUCCH for the periodic/semi-persistent CSI with normal BLER requirements is dropped.

In one implementation according to the present exemplary method, if the status of the positive SR with high priority is known before the start of the PUCCH for periodic/semi-persistent CSI with normal BLER requirements, the PUCCH for the positive SR with the high priority is transmitted, and the PUCCH for the periodic/semi-persistent CSI with normal BLER requirements is not transmitted.

In another implementation according to the present exemplary method, if a positive SR with high priority arrives after the start of the transmission of the PUCCH for periodic/semi-persistent CSI with normal BLER requirements, the PUCCH for the positive SR with high priority should be transmitted. The PUCCH for periodic/semi-persistent CSI with normal BLER requirements should be punctured by the PUCCH for the positive SR with high priority at least in the overlapping symbols. If there are remaining symbol(s) on the PUCCH for periodic/semi-persistent CSI with normal BLER requirements transmission, in one approach, the remaining symbol(s) on the PUCCH for periodic/semi-persistent CSI with normal BLER requirements transmission are also dropped. In another approach, the remaining symbol(s) on the PUCCH for periodic/semi-persistent CSI with normal BLER requirements transmission are resumed and still transmitted.

In the exemplary method described with reference to FIGS. 3A and 3B, the UE counts all SR configurations regardless of priority, multiplex with [log₂(k₁+1)] bits, where K₁ is the number of SR configurations that overlap with the PUCCH for periodic/semi-persistent CSI with normal BLER requirements with PUCCH format 2 or PUCCH format 3 or PUCCH format 4. The index of the positive SR with the highest priority is reported. Special handling may be needed under certain timing constraints or BLER performance criteria. According to various implementations of the present method, an SR with high priority has a higher priority than that of CSI. If the CSI and SR multiplexing cannot be performed (e.g., due to mismatch between timing constraints or BLR performance criteria), the PUCCH for a positive SR with high priority should be transmitted and the PUCCH for CSI may be dropped or punctured.

In the exemplary method described with reference to FIGS. 4A and 4B, for SR and periodic/semi-persistent CSI with normal BLER requirements multiplexing, the UE counts only SR with low priority configurations, multiplex with ┌ log₂(K₂+1)┐ bits, where K₂ is the number of SR with low priority configurations that overlap with the PUCCH for periodic/semi-persistent CSI with normal BLER requirements with PUCCH format 2 or PUCCH format 3 or PUCCH format 4. For a positive SR with high priority, the PUCCH for the positive SR with high priority is transmitted, and the PUCCH for periodic/semi-persistent CSI with normal BLER requirements is dropped or punctured. The exemplary method described with reference to FIGS. 4A and 4B provides a unified solution for channel dropping based on priority for positive SR with high priority. By counting only SRs with low priority, the extra bits of payload of SR indication is also reduced.

Case 2: PUCCH for Periodic/Semi-Persistent CSI with Ultra-Reliability Requirements

With the support of different service types, the PUCCH for a periodic/semi-persistent CSI feedback for a service type such as URLLC may be configured separately from the PUCCH for a periodic/semi-persistent CSI feedback for another service type, such as eMBB. The CSI feedback for URLLC may also require ultra-reliability (e.g., with a BLER target of 10\hat{ }−5 or less).

In various implementations of the present application, a UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) with ultra-reliability requirements from the UE in a resource using PUCCH format 2, PUCCH format 3, or PUCCH format 4 in a slot.

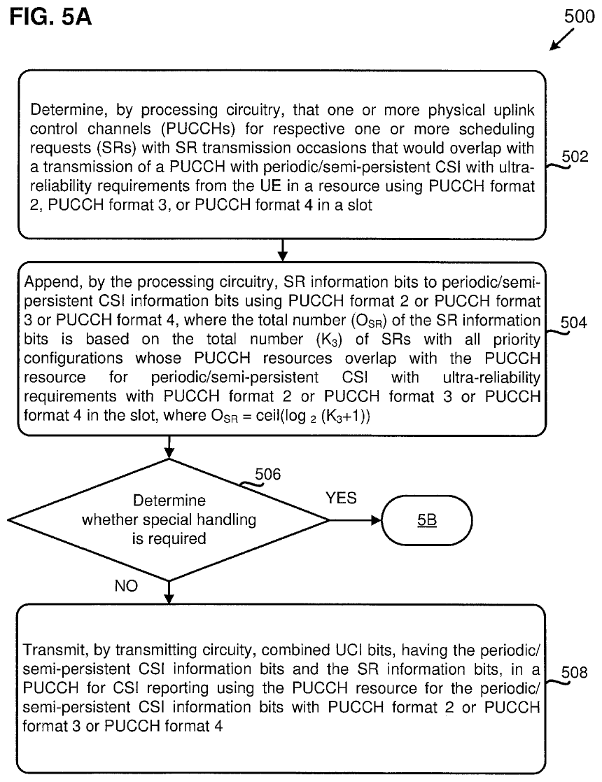

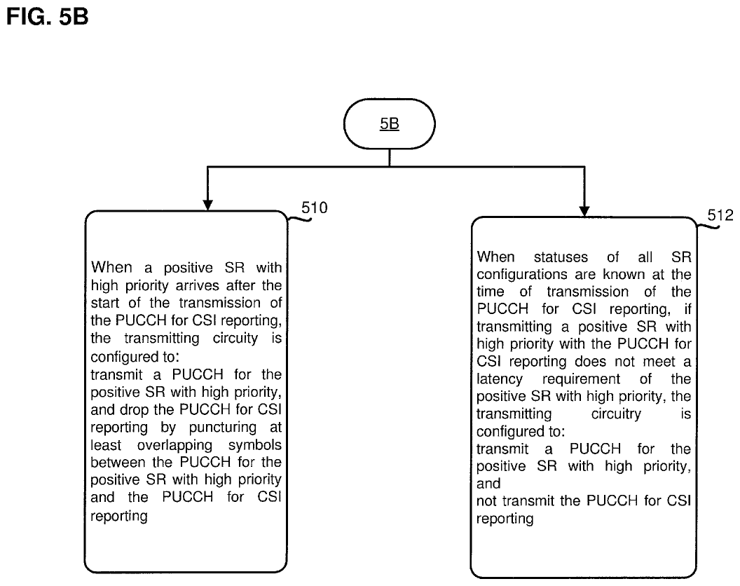

FIGS. 5A and 5B are a flowchart diagram illustrating a method of a UE for handling SRs with all priorities and CSI with ultra-reliability requirements, in accordance with example implementations of the present application. In the exemplary method shown in FIGS. 5A and 5B, the UE may count all SRs with all priority configurations whose PUCCH resources overlap with the PUCCH resource for periodic/semi-persistent CSI with ultra-reliability requirements with PUCCH format 2 or PUCCH format 3 or PUCCH format 4 in the slot. In case of at least one positive SR is triggered, the index of a positive SR with the highest priority is reported. As shown in FIGS. 5A and 5B, flowchart 500 includes actions 502, 504, 506, 508, 510, and 512.

In action 502, the UE may determine, by processing circuitry, that one or more physical uplink control channels (PUCCHs) for respective one or more scheduling requests (SRs) with SR transmission occasions that would overlap with a transmission of a PUCCH with periodic/semi-persistent CSI with ultra-reliability requirements from the UE in a resource using PUCCH format 2, PUCCH format 3, or PUCCH format 4 in a slot.

In action 504, the UE may append, by the processing circuitry, SR information bits to periodic/semi-persistent CSI information bits using PUCCH format 2 or PUCCH format 3 or PUCCH format 4, where the total number (O_{SR}) of the SR information bits is based on the total number (K₃) of SRs with all priority configurations whose PUCCH resources overlap with the PUCCH resource for periodic/semi-persistent CSI with ultra-reliability requirements with PUCCH format 2 or PUCCH format 3 or PUCCH format 4 in the slot. For example, the total number (O_{SR}) of the SR information bits may be obtained by O_{SR}=ceil(log₂(K₃+1))=┌ log₂(K₃+1)┐. In action 504, the UE may multiplex the SRs with CSI. In case of at least one positive SR is triggered, an index of a positive SR with the highest priority is reported by the SR information bits. Also, an all-zero value for the number (O_{SR}) of the SR information bits represents a negative SR value across all overlapping SRs.

In action 506, the UE may determine if special handling is required. If special handling is required, flowchart 500 may proceed to actions 510, and 512 in FIG. 5B. If special handling is not required, flowchart 500 may proceed to action 508.

In action 508, the UE may transmit, by transmitting circuitry, combined UCI bits, having the periodic/semi-persistent CSI information bits (e.g., corresponding to CSI with ultra-reliability requirements) and the SR information bits, in a PUCCH for CSI reporting using the PUCCH resource for the periodic/semi-persistent CSI information bits with PUCCH format 2 or PUCCH format 3 or PUCCH format 4.

When special handling is required as determined in action 506, flowchart 500 may proceed to actions 510 and 512 in FIG. 5B.

In action 510, when a positive SR with high priority arrives after the start of the transmission of the PUCCH for CSI reporting, the transmitting circuitry is configured to transmit a PUCCH for the positive SR with high priority, and drop the PUCCH for CSI reporting by puncturing at least overlapping symbols between the PUCCH for the positive SR with high priority and the PUCCH for CSI reporting.

In action 512, when statuses of all SR configurations are known at the time of transmission of the PUCCH for CSI reporting, if transmitting a positive SR with high priority with the PUCCH for CSI reporting does not meet a latency requirement of the positive SR with high priority, the transmitting circuitry is configured to transmit a PUCCH for the positive SR with high priority, and not transmit the PUCCH for CSI reporting.

In the present exemplary method, the UE would be configured to transmit K3 PUCCHs for respective K₃ SRs in a slot, as determined by a set of higher layer parameters schedulingRequestResourceId, with SR transmission occasions that would overlap with a transmission of a PUCCH with periodic/semi-persistent CSI information with ultra-reliability requirements from the UE in a slot.

In the present exemplary method, if the UE would transmit a PUCCH with periodic/semi-persistent CSI information bits with ultra-reliability requirements in a resource using PUCCH format 2 or PUCCH format 3 or PUCCH format 4 in the slot, ┌ log₂(K₃+1)┐ bits representing a negative or positive SR, in ascending order of the values of schedulingRequestResourceId, are appended to the periodic/semi-persistent CSI information bits with ultra-reliability requirements, and the UE transmits the combined UCI bits in a PUCCH using a resource with PUCCH format 2 or PUCCH format 3 or PUCCH format 4 for transmission of periodic/semi-persistent CSI information bits with ultra-reliability requirements.

The index of the positive SR with the highest priority is reported by the ┌ log₂(K₃+1)┐ bits. An all-zero value for the ┌ log₂(K₃+1)┐ bits represents a negative SR value across all K3 SRs.

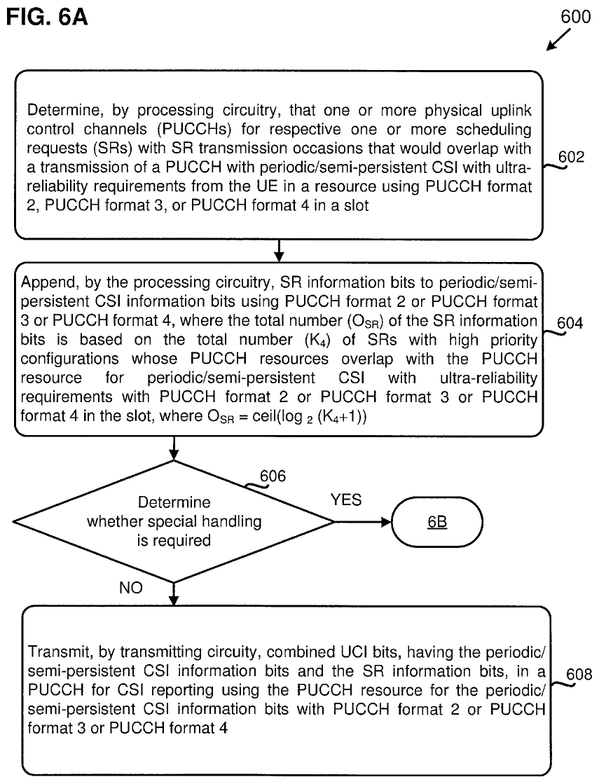

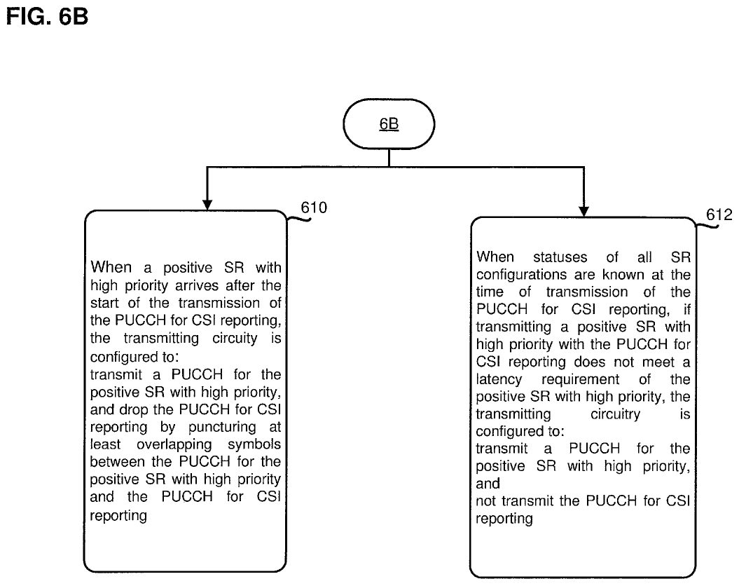

FIGS. 6A and 6B are flowchart diagram illustrating a method of a UE for handling SRs with all priorities with SR differentiation by multiplexing high priority SR and CSI with ultra-reliability requirements, in accordance with example implementations of the present application. In the exemplary method shown in FIG. 6, only SRs with high priority are multiplexed with CSI with ultra-reliability requirements. In the present implementation, the UE may count only SRs with high priority whose PUCCH resources overlap with the PUCCH resource for periodic/semi-persistent CSI with ultra-reliability requirements with PUCCH format 2 or PUCCH format 3 or PUCCH format 4 in the slot. As shown in FIGS. 6A and 6B, flowchart 600 includes actions 602, 604, 606, 608, 610, and 612.

In action 602, the UE may determine, by processing circuitry, that one or more physical uplink control channels (PUCCHs) for respective one or more scheduling requests (SRs) with SR transmission occasions that would overlap with a transmission of a PUCCH with periodic/semi-persistent CSI with ultra-reliability requirements from the UE in a resource using PUCCH format 2, PUCCH format 3, or PUCCH format 4 in a slot.

In action 604, the UE may append, by the processing circuitry, SR information bits to periodic/semi-persistent CSI information bits using PUCCH format 2 or PUCCH format 3 or PUCCH format 4, where the total number (O_{SR}) of the SR information bits is based on the total number (K₄) of SRs with high priority configurations whose PUCCH resources overlap with the PUCCH resource for periodic/semi-persistent CSI with ultra-reliability requirements with PUCCH format 2 or PUCCH format 3 or PUCCH format 4 in the slot. For example, the total number (O_{SR}) of the SR information bits may be obtained by O_{SR}=ceil(log₂(K₄+1))=┌ log₂(K₄+1)┐. In action 604, the UE may multiplex the SRs with CSI. In case of at least one positive SR is triggered, an index of a positive SR with the highest priority is reported by the SR information bits. Also, an all-zero value for the number (O_{SR}) of the SR information bits represents a negative SR value across all overlapping SRs.

In action 606, the UE may determine if special handling is required. If special handling is required, flowchart 600 may proceed to actions 610 and 612 in FIG. 6B. If special handling is not required, flowchart 600 may proceed to action 608.

In action 608, the UE may transmit, by transmitting circuitry, combined UCI bits, having the periodic/semi-persistent CSI information bits (e.g., corresponding to CSI with ultra-reliability requirements) and the SR information bits, in a PUCCH for CSI reporting using the PUCCH resource for the periodic/semi-persistent CSI information bits with PUCCH format 2 or PUCCH format 3 or PUCCH format 4.

When special handling is required as determined in action 606, flowchart 600 may proceed to actions 610 and 612 in FIG. 6B. Actions 610 and 612 in FIG. 6B may be substantially similar to actions 510 and 512 in FIG. 5B, respectively. Thus, the descriptions of actions 610 and 612 are omitted for brevity.

In the present exemplary method, to differentiate the SR priority, periodic/semi-persistent CSI with ultra-reliability requirements and SR multiplexing is performed based on priorities. Thus, SRs with low priority are not multiplexed with periodic/semi-persistent CSI with ultra-reliability requirements, and only SRs with high priority are counted in SR payload appended to periodic/semi-persistent CSI with ultra-reliability requirements. For example, K₄ is the number of SRs with high priority whose PUCCH resources overlap with the periodic/semi-persistent CSI with ultra-reliability requirements PUCCH transmission, ┌ log₂(K₄+1)┐ bits are added to the end of the periodic/semi-persistent CSI with ultra-reliability requirements. The SRs with low priority are ignored. For example, even if there is a positive SR with low priority, it is not reported together with the periodic/semi-persistent CSI with ultra-reliability requirements.

In the present exemplary method, the UE is configured to transmit K₄ PUCCHs for respective K₄ SRs with high priority in a slot, as determined by a set of higher layer parameters schedulingRequestResourceId, with SR transmission occasions that would overlap with a transmission of a PUCCH with periodic/semi-persistent CSI information with ultra-reliability requirements from the UE in a subslot.

In the present exemplary method, the UE would transmit a PUCCH with periodic/semi-persistent CSI information bits with ultra-reliability requirements in a resource using PUCCH format 2 or PUCCH format 3 or PUCCH fain at 4 in the slot, ┌ log₂(K₄+1)┐ bits representing a negative or positive SR with high priority, in ascending order of the values of schedulingRequestResourceId, are appended to the periodic/semi-persistent CSI information bits with ultra-reliability requirements and the UE transmits the combined UCI bits in a PUCCH using a resource with PUCCH format 2 or PUCCH format 3 or PUCCH format 4 for transmission of periodic/semi-persistent CSI information bits with ultra-reliability requirements. The index of the positive SR with high priority with the highest priority is reported by the ┌ log₂(K₄+1)┐ bits. An all-zero value for the ┌ log₂(K₄+1)┐ bits represents a negative SR value across all K4 SRs with high priority.

In various implementations of the present exemplary method, special handling with timing constraints still need to be specified under some timing constraints. According to implementations of the present method, an SR with high priority has a higher priority than that of CSI. If the CSI and SR multiplexing cannot be performed (e.g., due to mismatch between timing constraints or BLR performance criteria), the PUCCH for a positive SR with high priority should be transmitted, and the PUCCH for CSI may be dropped or punctured.

In one implementation according to the present exemplary method, if a positive SR with high priority arrives after the start of the transmission of the PUCCH for periodic/semi-persistent CSI, the positive SR with high priority cannot be reported together with the periodic/semi-persistent CSI. In such a case, the PUCCH for the positive SR with high priority should be transmitted. The PUCCH for periodic/semi-persistent CSI should be punctured by the PUCCH for the positive SR with high priority at least in the overlapping symbols. If there are remaining symbol(s) on the PUCCH for periodic/semi-persistent CSI transmission, in one approach, the remaining symbol(s) on the PUCCH for periodic/semi-persistent CSI transmission are also dropped. In another approach, the remaining symbol(s) on the PUCCH for periodic/semi-persistent CSI transmission are resumed and still transmitted.

In another implementation according to the present exemplary method, even if a positive SR with high priority is multiplexed with the periodic/semi-persistent CSI, if the end of the PUCCH for periodic/semi-persistent CSI is too late for a positive SR with high priority, the latency requirement may not be satisfied for an ultra-reliable and low latency traffic. In such a case, the PUCCH for the positive SR with high priority should be transmitted, and the PUCCH for periodic/semi-persistent CSI should be dropped and not transmitted.

In the exemplary method described with reference to FIGS. 5A and 5B, the UE counts all SR configurations regardless of priority, multiplex with ┌ log₂(K₃+1)┐ bits, where K₃ is the number of SR configurations that overlap with the PUCCH for periodic/semi-persistent CSI with ultra-reliability requirements with PUCCH format 2 or PUCCH format 3 or PUCCH format 4.

In the exemplary method described with reference to FIG. 6, the UE counts only SR with high priority configurations. Multiplex with ┌ log₂(K₄+1)┐ bits, where K₄ is the number of SR with high priority configurations that overlap with the PUCCH for periodic/semi-persistent CSI with ultra-reliability requirements with PUCCH format 2 or PUCCH format 3 or PUCCH format 4. SRs with low priority are ignored.

For both methods, special handling is applied under certain constraints. For example, if the CSI and SR multiplexing cannot be performed, the PUCCH for a positive SR with high priority should be transmitted and the PUCCH for CSI may be dropped or punctured.

### SUMMARY

In one example, a user equipment (UE) comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) with normal block error rate (BLER) requirements from the UE in a resource using PUCCH format 2, PUCCH format 3, or PUCCH format 4 in a slot, processing circuitry of the UE is configured to append SR information bits to periodic semi-persistent CSI information bits using PUCCH format 2 or PUCCH format 3 or PUCCH format 4; transmitting circuitry of the UE is configured to transmit combined uplink control information (UCI) bits, having the periodic/semi-persistent CSI information bits and the SR information bits, in a PUCCH for CSI reporting using the PUCCH resource for the periodic/semi-persistent CSI information bits with PUCCH format 2 or PUCCH format 3 or PUCCH format 4; wherein a number (O_{SR}) of the SR information bits is based on: a total number (K₁) of SRs with all priority configurations whose PUCCH resources overlap with the PUCCH resource for periodic/semi-persistent CSI with normal BLER requirements with PUCCH format 2 or PUCCH format 3 or PUCCH format 4 in the slot; or a total number (K₂) of SRs with low priority configurations whose PUCCH resources overlap with the PUCCH resource for periodic/semi-persistent CSI with normal BLER requirements with PUCCH format 2 or PUCCH format 3 or PUCCH format 4 in the slot.

In one example, the UE, wherein, when the number of SR information bits are based on the SRs with all priority configurations, the processing circuitry is configured to: obtain the number (O_{SR}) of the SR information bits by O_{SR}=ceil(log₂(K₁+1)), where the K₁ is the total number of the SRs with all priority configurations whose PUCCH resources overlap with the PUCCH resource for periodic/semi-persistent CSI with normal BLER requirements with PUCCH format 2 or PUCCH format 3 or PUCCH format 4 in the slot.

In one example, the UE, wherein, when the number of SR information bits is based on only the SRs with low priority configurations, the processing circuitry is configured to: ignore SRs with high priority configurations irrespective of whether the SRs are positive or negative; and obtain the number (O_{SR}) of the SR information bits by O_{SR}=ceil(log₂(K₂+1)), where the K₂ is the total number of the SRs with low priority configurations whose PUCCH resources overlap with the PUCCH resource for periodic/semi-persistent CSI with normal BLER requirements with PUCCH format 2 or PUCCH format 3 or PUCCH format 4 in the slot.

In one example, the UE, wherein, if a positive SR with high priority arrives after a start of the transmission of the PUCCH for CSI reporting, the transmitting circuitry is configured to: transmit a PUCCH for the positive SR with high priority, and drop the PUCCH for CSI reporting by puncturing at least overlapping symbols between the PUCCH for the positive SR with high priority and the PUCCH for CSI reporting.

In one example, the UE, wherein, when statuses of all SR configurations are known at the time of transmission of the PUCCH for CSI reporting, if transmitting a positive SR with high priority with the PUCCH for CSI reporting does not meet a latency requirement of the positive SR with high priority, the transmitting circuitry is configured to transmit a PUCCH for the positive SR with high priority, and not transmit the PUCCH for CSI reporting.

In one example, the UE, wherein, when a desired miss detection probability of SRs with high priority is much lower than the periodic/semi-persistent CSI or SRs with low priority, if a positive SR with high priority is triggered, the transmitting circuitry is configured to: transmit a PUCCH for the positive SR with high priority, and not transmit the PUCCH for CSI reporting or drop the PUCCH for CSI reporting by puncturing at least overlapping symbols between the PUCCH for the positive SR with high priority and the PUCCH for CSI reporting.

In one example, the UE, wherein an index of a positive SR with the highest priority is reported by the SR information bits, and an all-zero value for the number (O_{SR}) of the SR information bits represents a negative SR value across all overlapping SRs.

In one example, the UE, wherein when a PUCCH resource for the periodic/semi-persistent CSI is configured for URLLC service type traffic, the periodicity of the PUCCH resource for the periodic/semi-persistent CSI is reduced to 1 or 2 slots, or configured based on a number of subslots.

In one example, a method by a user equipment (UE), the method comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) with normal block error rate (BLER) requirements from the UE in a resource using PUCCH format 2, PUCCH format 3, or PUCCH format 4 in a slot, appending SR information bits to periodic/semi-persistent CSI information bits using PUCCH format 2 or PUCCH format 3 or PUCCH format 4; transmitting combined uplink control information (UCI) bits, having the periodic/semi-persistent CSI information bits and the SR information bits, in a PUCCH for CSI reporting using the PUCCH resource for the periodic/semi-persistent CSI information bits with PUCCH format 2 or PUCCH format 3 or PUCCH format 4; wherein a number (O_{SR}) of the SR information bits is based on: a total number (K₁) of SRs with all priority configurations whose PUCCH resources overlap with the PUCCH resource for periodic/semi-persistent CSI with normal BLER requirements with PUCCH format 2 or PUCCH format 3 or PUCCH format 4 in the slot; or a total number (K₂) of SRs with low priority configurations whose PUCCH resources overlap with the PUCCH resource for periodic/semi-persistent CSI with normal BLER requirements with PUCCH format 2 or PUCCH format 3 or PUCCH format 4 in the slot.

In one example, the method, wherein, when the number of SR information bits are based on the SRs with all priority configurations, the method further comprising: obtaining the number (O_{SR}) of the SR information bits by O_{SR}=ceil(log₂(K₁+1)), where the K₁ is the total number of the SRs with all priority configurations whose PUCCH resources overlap with the PUCCH resource for periodic/semi-persistent CSI with normal BLER requirements with PUCCH format 2 or PUCCH format 3 or PUCCH format 4 in the slot.

In one example, the method, wherein, when the number of SR information bits is based on only the SRs with low priority configurations, the method further comprising: ignoring SRs with high priority configurations irrespective of whether the SRs are positive or negative; and obtaining the number (O_{SR}) of the SR information bits by O_{SR}=ceil(log₂(K₂+1)), where the K₂ is the total number of the SRs with low priority configurations whose PUCCH resources overlap with the PUCCH resource for periodic/semi-persistent CSI with normal BLER requirements with PUCCH format 2 or PUCCH format 3 or PUCCH format 4 in the slot.

In one example, the method, wherein, if a positive SR with high priority arrives after a start of the transmission of the PUCCH for CSI reporting, the method further comprising: transmitting a PUCCH for the positive SR with high priority, and drop the PUCCH for CSI reporting by puncturing at least overlapping symbols between the PUCCH for the positive SR with high priority and the PUCCH for CSI reporting.

In one example, the method, wherein, when statuses of all SR configurations are known at the time of transmission of the PUCCH for CSI reporting, if transmitting a positive SR with high priority with the PUCCH for CSI reporting does not meet a latency requirement of the positive SR with high priority, the method further comprising: transmitting a PUCCH for the positive SR with high priority, and not transmitting the PUCCH for CSI reporting.

In one example, the method, wherein, when a desired miss detection probability of SRs with high priority is much lower than the periodic/semi-persistent CSI or SRs with low priority, if a positive SR with high priority is triggered, the method further comprising:

transmitting a PUCCH for the positive SR with high priority, and not transmitting the PUCCH for CSI reporting or drop the PUCCH for CSI reporting by puncturing at least overlapping symbols between the PUCCH for the positive SR with high priority and the PUCCH for CSI reporting.

In one example, the method, wherein an index of a positive SR with the highest priority is reported by the SR information bits, and an all-zero value for the number (O_{SR}) of the SR information bits represents a negative SR value across all overlapping SRs.

In one example, the method, wherein when a PUCCH resource for the periodic/semi-persistent CSI is configured for URLLC service type traffic, the periodicity of the PUCCH resource for the periodic/semi-persistent CSI is reduced to 1 or 2 slots, or configured based on a number of subslots.

In one example, a user equipment (UE) comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) with ultra-reliability requirements from the UE in a resource using PUCCH format 2, PUCCH format 3, or PUCCH format 4 in a slot, processing circuitry of the UE is configured to append SR information bits to periodic/semi-persistent CSI information bits using PUCCH format 2 or PUCCH format 3 or PUCCH format 4; transmitting circuitry of the UE is configured to transmit combined uplink control information (UCI) bits, having the periodic/semi-persistent CSI information bits and the SR information bits, in a PUCCH for CSI reporting using the PUCCH resource for the periodic/semi-persistent CSI information bits with using PUCCH format 2 or PUCCH format 3 or PUCCH format 4; wherein a number (O_{SR}) of the SR information bits is based on: a total number (K₃) of SRs with all priority configurations whose PUCCH resources overlap with the PUCCH resource for periodic/semi-persistent CSI with ultra-reliability requirements with using PUCCH format 2 or PUCCH format 3 or PUCCH format 4 in the slot; or a total number (K₄) of SRs with high priority configurations whose PUCCH resources overlap with the PUCCH resource for periodic/semi-persistent CSI with ultra-reliability requirements with using PUCCH format 2 or PUCCH format 3 or PUCCH format 4 in one or more subslots of the slot.

In one example, the UE, wherein, when the number of SR information bits are based on the SRs with all priority configurations, the processing circuitry is configured to: obtain the number (O_{SR}) of the SR information bits by O_{SR}=ceil(log₂(K₃+1)), where the K₃ is the total number of the SRs with all priority configurations whose PUCCH resources overlap with the PUCCH resource for periodic/semi-persistent CSI with ultra-reliability requirements with PUCCH format 2 or PUCCH format 3 or PUCCH format 4 in the slot.

In one example, the UE, wherein, when the number of SR information bits is based on only the SRs with high priority configurations, the processing circuitry is configured to: ignore SRs with low priority configurations irrespective of whether the SRs are positive or negative; and obtain the number (O_{SR}) of the SR information bits by O_{SR}=ceil(log₂(K₄+1)), where the K₄ is the total number of the SRs with low priority configurations whose PUCCH resources overlap with the PUCCH resource for periodic/semi-persistent CSI with ultra-reliability requirements with PUCCH format 2 or PUCCH format 3 or PUCCH format 4 in the slot.

In one example, the UE, wherein, when a positive SR with high priority arrives after the start of the transmission of the PUCCH for CSI reporting, the transmitting circuitry is configured to: transmit a PUCCH for the positive SR with high priority, and drop the PUCCH for CSI reporting by puncturing at least overlapping symbols between the PUCCH for the positive SR with high priority and the PUCCH for CSI reporting.

In one example, the UE, wherein, when statuses of all SR configurations are known at the time of transmission of the PUCCH for CSI reporting, if transmitting a positive SR with high priority with the PUCCH for CSI reporting does not meet a latency requirement of the positive SR with high priority, the transmitting circuitry is configured to transmit a PUCCH for the positive SR with high priority, and not transmit the PUCCH for CSI reporting.

In one example, the UE, wherein an index of a positive SR with the highest priority is reported by the SR information bits, and an all-zero value for the number (O_{SR}) of the SR information bits represents a negative SR value across all overlapping SRs.

In one example, the UE, wherein when a PUCCH resource for the periodic/semi-persistent CSI is configured for URLLC service type traffic, the periodicity of the PUCCH resource for the periodic/semi-persistent CSI is reduced to 1 or 2 slots, or configured based on a number of subslots.

In one example, the UE, wherein a PUCCH resource for the periodic/semi-persistent CSI is configured for URLLC service type traffic, the PUCCH resource for the periodic/semi-persistent CSI is configured with a PUCCH format with ultra-reliability BLER requirements.

In one example, a method by a user equipment (UE), the method comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) with ultra-reliability requirements from the UE in a resource using PUCCH format 2, PUCCH format 3, or PUCCH format 4 in a slot, appending SR information bits to periodic/semi-persistent CSI information bits using PUCCH format 2 or PUCCH format 3 or PUCCH format 4; transmitting combined uplink control information (UCI) bits, having the periodic/semi-persistent CSI information bits and the SR information bits, in a PUCCH for CSI reporting using the PUCCH resource for the periodic/semi-persistent CSI information bits with using PUCCH format 2 or PUCCH format 3 or PUCCH format 4; wherein a number (O_{SR}) of the SR information bits is based on: a total number (K₃) of SRs with all priority configurations whose PUCCH resources overlap with the PUCCH resource for periodic/semi-persistent CSI with ultra-reliability requirements with using PUCCH format 2 or PUCCH format 3 or PUCCH format 4 in the slot; or a total number (K₄) of SRs with high priority configurations whose PUCCH resources overlap with the PUCCH resource for periodic/semi-persistent CSI with ultra-reliability requirements with using PUCCH format 2 or PUCCH format 3 or PUCCH format 4 in one or more subslots of the slot.

In one example, the method, wherein, when the number of SR information bits are based on the SRs with all priority configurations, the method further comprising: obtaining the number (O_{SR}) of the SR information bits by O_{SR}=ceil(log₂(K₃+1)), where the K₃ is the total number of the SRs with all priority configurations whose PUCCH resources overlap with the PUCCH resource for periodic/semi-persistent CSI with ultra-reliability requirements with PUCCH format 2 or PUCCH format 3 or PUCCH format 4 in the slot.

In one example, the method, wherein, when the number of SR information bits is based on only the SRs with high priority configurations, the method further comprising: ignoring SRs with low priority configurations irrespective of whether the SRs are positive or negative; and obtaining the number (O_{SR}) of the SR information bits by O_{SR}=ceil(log₂(K₄+1)), where the K₄ is the total number of the SRs with low priority configurations whose PUCCH resources overlap with the PUCCH resource for periodic/semi-persistent CSI with ultra-reliability requirements with PUCCH format 2 or PUCCH format 3 or PUCCH format 4 in the slot.

In one example, the method, wherein, when a positive SR with high priority arrives after the start of the transmission of the PUCCH for CSI reporting, the method further comprising: transmitting a PUCCH for the positive SR with high priority, and drop the PUCCH for CSI reporting by puncturing at least overlapping symbols between the PUCCH for the positive SR with high priority and the PUCCH for CSI reporting.

In one example, the method, wherein, when statuses of all SR configurations are known at the time of transmission of the PUCCH for CSI reporting, if transmitting a positive SR with high priority with the PUCCH for CSI reporting does not meet a latency requirement of the positive SR with high priority, the method further comprising: transmitting a PUCCH for the positive SR with high priority, and not transmit the PUCCH for CSI reporting.

In one example, the method, wherein an index of a positive SR with the highest priority is reported by the SR information bits, and an all-zero value for the number (O_{SR}) of the SR information bits represents a negative SR value across all overlapping SRs.

In one example, the method, wherein when a PUCCH resource for the periodic/semi-persistent CSI is configured for URLLC service type traffic, the periodicity of the PUCCH resource for the periodic/semi-persistent CSI is reduced to 1 or 2 slots, or configured based on a number of subslots.

In one example, the method, wherein a PUCCH resource for the periodic/semi-persistent CSI is configured for URLLC service type traffic, the PUCCH resource for the periodic/semi-persistent CSI is configured with a PUCCH format with ultra-reliability BLER requirements.

In one example, a user equipment (UE) comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, processing circuitry of the UE is configured to prepend SR information bits to periodic/semi-persistent CSI information bits using PUCCH format 2 or PUCCH format 3 or PUCCH format 4; and determine a PUCCH to be transmitted based on whether a high priority SR is to be reported; transmitting circuitry of the UE is configured to transmit the selected PUCCH.

In one example, the UE, wherein the number of SR information bits is based on only the SRs with low priority configurations, the processing circuitry is configured to: ignore SRs with high priority configurations irrespective of whether the SRs are positive or negative; and obtain the number (O_{SR}) of the SR information bits by O_{SR}=ceil(log₂(K₂+1)), where the K₂ is the total number of the SRs with low priority configurations whose PUCCH resources overlap with the PUCCH resource for periodic/semi-persistent CSI with PUCCH format 2 or PUCCH format 3 or PUCCH format 4 in the slot.

In one example, the UE, if there is no positive SR with high priority to be reported, the transmitting circuitry is configured to: transmit the combined uplink control information (UCI) bits, having the periodic/semi-persistent CSI information bits and the SR information bits, in a PUCCH for CSI reporting using the PUCCH resource for the periodic/semi-persistent CSI information bits with PUCCH format 2 or PUCCH format 3 or PUCCH format 4; wherein a number (O_{SR}) of the SR information bits is based on a total number (K₂) of SRs with low priority configurations whose PUCCH resources overlap with the PUCCH resource for periodic/semi-persistent CSI with PUCCH format 2 or PUCCH format 3 or PUCCH format 4 in the slot.

In one example, the UE, if a positive SR with high priority is to be reported, the transmitting circuitry is configured to: transmit a PUCCH for the positive SR with high priority, and drop or not transmit the PUCCH for CSI reporting or drop the PUCCH for CSI reporting.

In one example, a method by a user equipment (UE), the method comprising: when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, prepending SR information bits to periodic/semi-persistent CSI information bits using PUCCH format 2 or PUCCH format 3 or PUCCH format 4; and determining a PUCCH to be transmitted based on whether a high priority SR is to be reported; transmitting the selected PUCCH.

In one example, the method, wherein the number of SR information bits is based on only the SRs with low priority configurations: ignoring SRs with high priority configurations irrespective of whether the SRs are positive or negative; and obtaining the number (O_{SR}) of the SR information bits by O_{SR}=ceil(log₂(K₂+1)), where the K₂ is the total number of the SRs with low priority configurations whose PUCCH resources overlap with the PUCCH resource for periodic/semi-persistent CSI with PUCCH format 2 or PUCCH format 3 or PUCCH format 4 in the slot.

In one example, the method, if there is no positive SR with high priority to be reported: transmitting the combined uplink control information (UCI) bits, having the periodic/semi-persistent CSI information bits and the SR information bits, in a PUCCH for CSI reporting using the PUCCH resource for the periodic/semi-persistent CSI information bits with PUCCH format 2 or PUCCH format 3 or PUCCH format 4; wherein a number (O_{SR}) of the SR information bits is based on a total number (K₂) of SRs with low priority configurations whose PUCCH resources overlap with the PUCCH resource for periodic/semi-persistent CSI with PUCCH format 2 or PUCCH format 3 or PUCCH format 4 in the slot.

In one example, the method, if a positive SR with high priority is to be reported: transmitting a PUCCH for the positive SR with high priority, and dropping or not transmitting the PUCCH for CSI reporting or drop the PUCCH for CSI reporting.

In one example, a gNB comprising: when the gNB configures a UE to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, processing circuitry of the gNB is configured to determine a PUCCH is received at the configured PUCCH resources receive the uplink control information (UCI) on the PUCCH.

In one example, the gNB, if a PUCCH is received on a PUCCH resource for the CSI report with PUCCH format 2 or PUCCH format 3 or PUCCH format 4; the gNB determines that there is no positive SR with high priority reported, and receives combined uplink control information (UCI) bits, having the HARQ-ACK information bits and the SR information bits; wherein a number (O_{SR}) of the SR information bits is based on a total number (K₂) of SRs with low priority configurations whose PUCCH resources overlap with the PUCCH resource for periodic/semi-persistent CSI with PUCCH format 2 or PUCCH format 3 or PUCCH format 4 in the slot.

In one example, the gNB, if a PUCCH is received on a PUCCH resource configured for a SR with high priority, the gNB receives a positive SR with high priority with the SR index given by the PUCCH resource configuration, and the CSI report is dropped.

In one example, a method by a gNB, the method comprising: when the gNB configures a UE to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot, determining a PUCCH is received at the configured PUCCH resources receiving the uplink control information (UCI) on the PUCCH.

In one example, the method, if a PUCCH is received on a PUCCH resource for the CSI report with PUCCH format 2 or PUCCH format 3 or PUCCH format 4; determining that there is no positive SR with high priority reported, and receiving combined uplink control information (UCI) bits, having the HARQ-ACK information bits and the SR information bits; wherein a number (O_{SR}) of the SR information bits is based on a total number (K₂) of SRs with low priority configurations whose PUCCH resources overlap with the PUCCH resource for periodic/semi-persistent CSI with PUCCH format 2 or PUCCH format 3 or PUCCH format 4 in the slot.

In one example, the method, if a PUCCH is received on a PUCCH resource configured for a SR with high priority, receiving a positive SR with high priority with the SR index given by the PUCCH resource configuration, and the CSI report is dropped.

### CROSS REFERENCE

This Nonprovisional application claims priority under 35 U.S.C. § 119 on provisional Application No. 62,878,179 on Jul. 24, 2019, the entire contents of which are hereby incorporated by reference.

What is claimed is:

1. A user equipment (UE) comprising:
when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot,
processing circuitry of the UE is configured to prepend SR information bits to periodic/semi-persistent CSI information bits using PUCCH format 2 or PUCCH format 3 or PUCCH format 4; and
determine a PUCCH to be transmitted based on whether a high priority SR is to be reported;
transmitting circuitry of the UE is configured to transmit the selected PUCCH.

2. The UE of claim 1, wherein the number of SR information bits is based on only the SRs with low priority configurations, the processing circuitry is configured to:
ignore SRs with high priority configurations irrespective of whether the SRs are positive or negative; and
obtain the number (O_{SR}) of the SR information bits by O_{SR}=ceil(log₂(K₂+1)), where the K₂ is the total number of the SRs with low priority configurations whose PUCCH resources overlap with the PUCCH resource for periodic/semi-persistent CSI with PUCCH format 2 or PUCCH format 3 or PUCCH format 4 in the slot.

3. The UE of claim 1, if there is no positive SR with high priority to be reported, the transmitting circuitry is configured to:
transmit the combined uplink control information (UCI) bits, having the periodic/semi-persistent CSI information bits and the SR information bits, in a PUCCH for CSI reporting using the PUCCH resource for the periodic/semi-persistent CSI information bits with PUCCH format 2 or PUCCH format 3 or PUCCH format 4;
wherein a number (O_{SR}) of the SR information bits is based on a total number (K₂) of SRs with low priority configurations whose PUCCH resources overlap with the PUCCH resource for periodic/semi-persistent CSI with PUCCH format 2 or PUCCH format 3 or PUCCH format 4 in the slot.

4. The UE of claim 1, if a positive SR with high priority is to be reported, the transmitting circuitry is configured to:
transmit a PUCCH for the positive SR with high priority, and
drop or not transmit the PUCCH for CSI reporting or drop the PUCCH for CSI reporting.

5. A method by a user equipment (UE), the method comprising:
when the UE is configured to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot,
prepending SR information bits to periodic/semi-persistent CSI information bits using PUCCH format 2 or PUCCH format 3 or PUCCH format 4; and
determining a PUCCH to be transmitted based on whether a high priority SR is to be reported;
transmitting the selected PUCCH.

6. (canceled)

7. (canceled)

8. (canceled)

9. A gNB comprising:
when the gNB configures a UE to transmit one or more physical uplink control channels (PUCCHs) for respective one or more scheduling requests (SRs) with SR transmission occasions that would overlap with a transmission of a PUCCH with periodic/semi-persistent Channel State Information (CSI) from the UE in a resource using PUCCH format 2, PUCCH format 3, or PUCCH format 4 in a slot,
processing circuitry of the gNB is configured to determine a PUCCH is received at the configured PUCCH resources
receive the uplink control information (UCI) on the PUCCH.

10. The gNB of claim 9, if a PUCCH is received on a PUCCH resource for the CSI report with PUCCH format 2 or PUCCH format 3 or PUCCH format 4; the gNB
determines that there is no positive SR with high priority reported, and
receives combined uplink control information (UCI) bits, having the HARQ-ACK information bits and the SR information bits;
wherein a number (O_{SR}) of the SR information bits is based on a total number (K₂) of SRs with low priority configurations whose PUCCH resources overlap with the PUCCH resource for periodic/semi-persistent CSI with PUCCH format 2 or PUCCH format 3 or PUCCH format 4 in the slot.

11. The gNB of claim 9, if a PUCCH is received on a PUCCH resource configured for a SR with high priority, the gNB
receives a positive SR with high priority with the SR index given by the PUCCH resource configuration, and the CSI report is dropped.

12. (canceled)

13. (canceled)

14. (canceled)
